(19) United States
(12) Patent Application Publication
(10) Pub. No.: US 2007/0203875 A1
(43) Pub. Date: Aug. 30, 2007

(54) System and method for retrieving files from a file server using file attributes

(75) Inventors: Ellis K. Cave, Plano, TX (US); David C. Cheng, Plano, TX (US)

Correspondence Address: FULBRIGHT & JAWORSKI L.L.P, 2200 ROSS AVENUE, SUITE 2800, DALLAS, TX, 75201-2784, US

(73) Assignee: InterVoice Limited Partnership, Dallas, TX (US)

(21) Appl. No.: 11/361,848

(22) Filed: Feb. 24, 2006

(51) Int. Cl. G06F 17/30

(52) U.S. Cl. 707/1

(57) ABSTRACT

There is disclosed systems and methods for retrieving files from a file server using file attributes. In one embodiment, an audio file server is accessed to retrieve prerecorded audio files using file attributes. In one embodiment, the HTTP protocol is used by adding query attributes, such as a text version of the desired message, along with other required attributes of the audio file, to the audio file server. The audio file server accepts the attributes, including the message text attributes and parses them to resolve which audio (.wav) message to retrieve. The retrieved audio file is then returned to the voice browser, which normally plays the message. In this way, IVR application developers can specify the content, speaker, language, dialect, emotion, and other attributes of a required audio file utilizing standard voice browsers to access audio files.

### CONCURRENTLY FILED APPLICATIONS

The present application is related to copending and commonly assigned U.S. patent application Ser. No. ______ [Attorney Docket No. 47524-P137US-10501428] entitled “SYSTEM AND METHOD FOR MANAGING FILES ON A FILE SERVER USING EMBEDDED METADATA AND A SEARCH ENGINE,” U.S. patent application Ser. No. ______ [Attorney Docket 47524-P139US-10503962] entitled “SYSTEM AND METHOD FOR DEFINING AND INSERTING METADATA ATTRIBUTES IN FILES,” and U.S. patent application Ser. No. ______ [Attorney Docket No. 47524-P140US-10506201] entitled “SYSTEM AND METHOD FOR DEFINING, SYNTHESIZING AND RETRIEVING VARIABLE FIELD UTTERANCES FROM A FILE SERVER,” filed concurrently herewith, the disclosures of which are hereby incorporated herein by reference.

### TECHNICAL FIELD

This invention relates to file storage, organization in general, and more particularly to the retrieving a file from a file server using one or more file attributes using standard internet protocols.

### BACKGROUND OF THE INVENTION

It is now commonplace to retrieve data files from storage locations. In the traditional situation, files are stored on the same system handling the request for the file. Situations arise where it is desired to have several clients access a common set of files. This can be accomplished by setting up a file storage arrangement that is shared across a network. In such file storage arrangements, whether the arrangement serves one client or a plurality of clients, the desired file is retrieved by specifying the name of the file, as well as the full directory path to the file, when required. Thus, files may be moved about over the network arbitrarily.

Such an arrangement has problems when metadata is associated with the different files. Typically, metadata associated with a file is placed in a separate database. Thus, the database must be moved each time a file is moved.

In addition, the storage of files is typically done by placing the file in a folder, somewhere in hierarchical directory structure. Using hierarchical structures have a flaw in that they require the person filing a document to pick a specific attribute about that file so that a specific folder can be selected to store the file in. Ideally, all of the files in that specific folder would have the same common attribute. However, a file may have several attributes (for example author, subject, language, etc.) that are important to that file. The dilemma faced by the person creating the file structure, is how to create a hierarchical structure where some people want to find the files by one attribute, such as author, while other people may want to find the files by another attribute, such as subject, and while still others by language. In order to allow the same document to be found in by searching different attributes, e.g. the author, subject, and language folders, one would need to create three copies of the document, and put one copy in each type folder.

One example of a complex file structure is the audio file structure used in interactive voice response (IVR) systems. In order for a script to play a specific audio file, the <audio> tag in the script must provide a fully resolved address or URL pointing to the web address where the desired audio file resides. The fully resolved address is a complete address to the file through the existing hierarchical structure. The server then directs the request to the desired address and the desired audio file is retrieved from the specified address.

While a hierarchical directory structure with full path-name access is effective, it has some drawbacks. Many applications, particularly media applications which use audio files, have thousands of such audio files. An application may have the same audio files recorded in multiple languages, multiple speakers, or different emotional tones (stem, happy). Deciding on a hierarchical folder and file-naming scheme can be a challenge. Should one file the files according to language? To speaker? To content? If one files according to language, how does one find all the files by a specific speaker? Thus, using a hierarchical storage structure and fully resolved path names to retrieve a particular file is cumbersome and often limiting. Storing files in a nonhierarchical structure and requesting the files by attribute, provides a more flexible approach to file access than hierarchical structures.

### BRIEF SUMMARY OF THE INVENTION

There is disclosed systems and methods for retrieving files from a file server using file attributes. In one embodiment, a file request is formed from a string of file attributes using the HTTP protocol. For example, suppose a desired file comprises a text document, then the file attributes that may be used may include one or more of file-type, version, date, font, content, language, and/or author. These attributes are placed after a “?” in the URL address string. The HTTP query protocol is such that all of the attributes which follow the “?” will be passed unmodified through intermediary elements such as a browser, so that the full attribute list reaches the file server for resolution. The audio file server accepts the attributes and parses them to resolve which file to retrieve. Note that more than one file may be retrieved or located by the request. The retrieved file is then returned to the requesting user browser.

One type of file server is an audio file server (AFS) for use in interactive voice recognition (IVR) systems. VXML or SALT browsers interpret VXML or SALT script documents to determine dialog flow. VXML or SALT scripts can contain requests to play audio files as part of the dialog. Normally, the audio file play request must contain a fully-resolved path to the appropriate audio file for the audio file server to access the file. Using an attribute-based files server according to an embodiment of the invention, the scripts can specify URLs with attribute lists instead of paths. Query attributes such as a text version of the desired message along with other attributes required in the audio file, such as recorded by John, spoken in a happy voice, spoken in English, etc may be used to retrieve a particular file. The attribute list is constructed in such a way in the request that browsers will pass the attribute list unchanged to the audio file server. Thus, the audio file server is accessed to retrieve pre-recorded audio files using file attributes.

In this way, IVR application developers can specify many attributes of the required audio file, including the content, speaker, language, dialect, emotion, and other attributes and utilize standard voice browsers to access those files without having to know the specific hierarchical path of the location of the file in the server.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. Many other methodologies could be used to present attribute lists to a file server. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIGS. 1A and 1B show a typical prior art system for retrieving files, such as audio files, from a server using full-path names to specify the files required, and show a traditional prior art full-path URL to retrieve an audio file, respectfully;

FIGS. 2A-2C show a system for attribute-based retrieval of files; show a general example of an attribute-based URL used to retrieve files; and show a specific example of an attribute-based URL to retrieve a specific file, respectively; and

FIGS. 3A-3C show an embodiment of a system for retrieving audio files from a file server using a request URL with metadata attributes instead of path names, and show more examples of attribute-based URLs used to retrieve files.

### DETAILED DESCRIPTION OF THE INVENTION

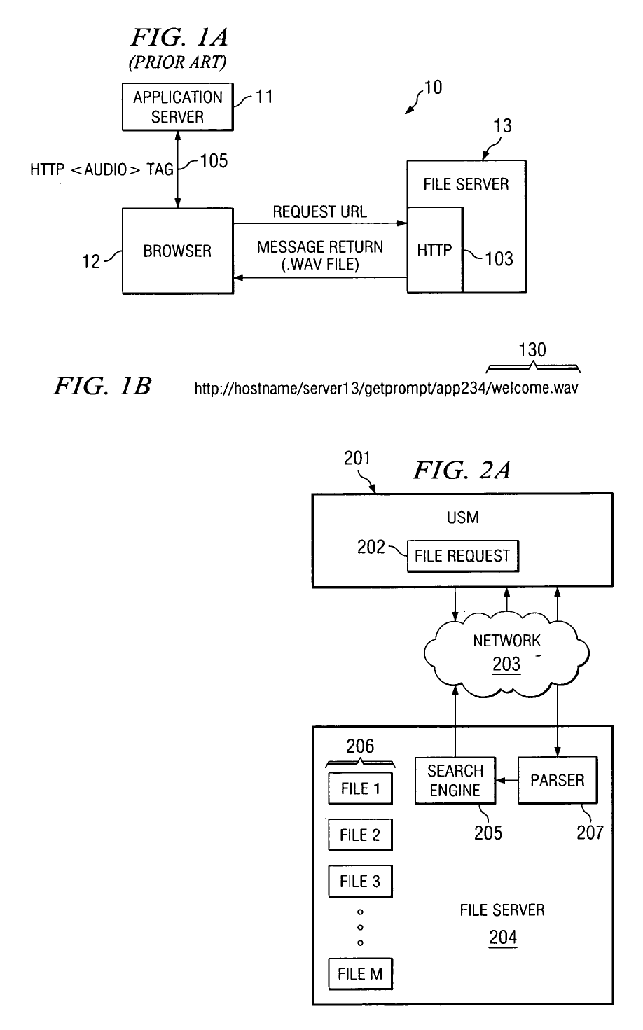

FIG. 1A shows a typical prior art system 10 used in IVR systems and having application server 11 interfacing with browser 12. Browser 12 can be configured with HTTP protocol and can interface with audio file server 13 via HTTP interface 103 using the <audio> tag with full path names as discussed above.

FIG. 1B shows an example of a URL specifying a full-path address to a specific audio file, such as: http://hostname/Server13/getprompt/app234/welcome.wav of the desired file. This is a fully resolved address and thus browser 12 (FIG. 1) sends a message to server 13 to retrieve the file located in file folder app 234 with the file being known as “welcome.wav”. The welcome.wav file contains the message “welcome to XYZ company.” Note that portion 130 is the message that is expected in file location 234. However, if the content of the file in location 234 had been changed, then portion 130 would be wrong.

The method just discussed assumes that the full path route to the desired file is known and used. This is a fully resolved address location.

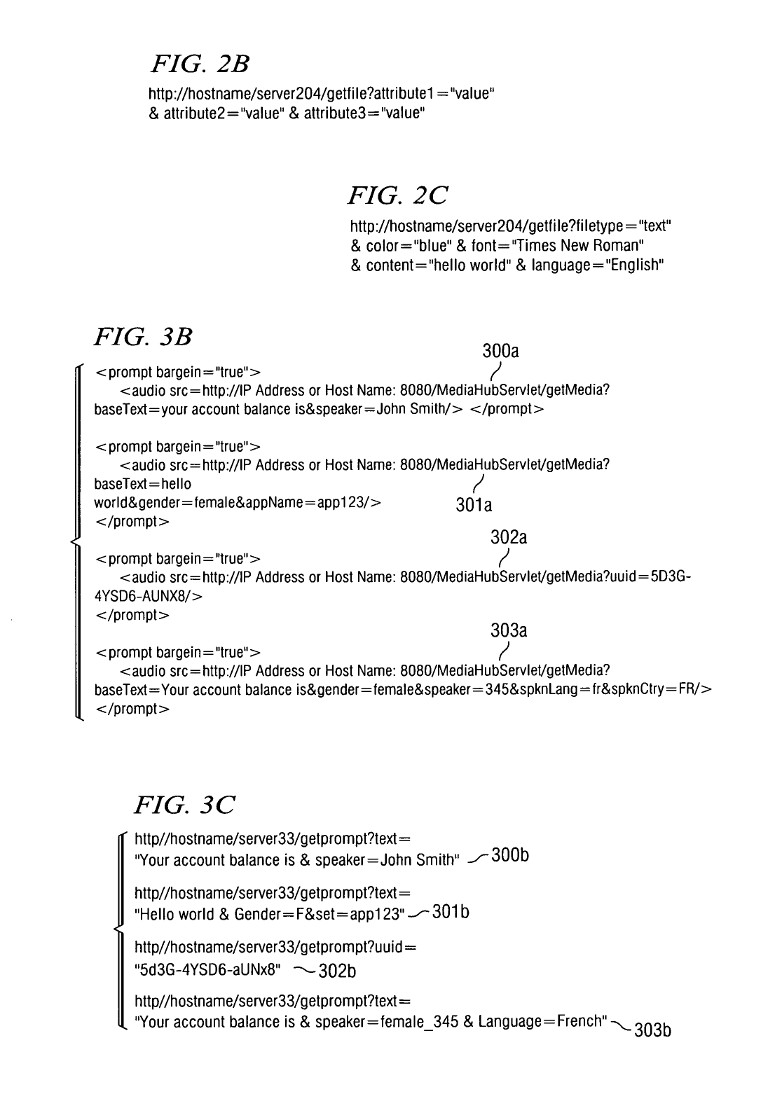

FIG. 2A depicts an example of an embodiment of a system 200 for retrieving files from a file server. In system 200, a user 201 desires to retrieve and/or locate a particular file or files that are stored in server 204. Note that the user may be a person that desires a file or a process that needs a file for its operation. Further note that there may be more than one user that is communicating with the server 204.

User 201 communicates with server 204 through a network 203. The network may be a LAN, a WAN, a WIFI, the Internet, or other network connection. Note that user 201 may be directly connected with server 204 without a network connection. For example, the server may be a personal computer and the user may be accessing a files stored therein.

To locate a particular file, the user generates a file request 202 that comprises a plurality of file attributes instead of a location path in the server. The file request is placed with a URL request that is delivered to the file server 204.

The file server 204 includes a plurality of files 206, namely file 1 to file M, and a search engine 205. The parser 207 receives the request 202 and parses the attributes from the URL request 202. The attributes are then passed to the search engine 205. The search engine 205 uses the attributes to locate a particular file or files to satisfy the file request 202.

The file request 202 generated by the user 201 takes advantage of the HTTP protocol which allows data contained in a communication line to be passed to a target destination if that data falls after the query marker “?” in the communication line. This is known as a query URL and in the context of this disclosure it is also known as request URL. The W3C standard for URLs allows a question mark followed by any data intended for the final recipient of the request. Data following the “?” is defined as a “request”, which will be ignored by intermediate entities handling the request. The request data is intended to be handled and acted upon by the final server targeted in the URL. Thus, by establishing file server 204 as the target, an application from the user 201 creates a request using a scripting protocol. FIG. 2B depicts the general format of a file request that comprises three different attributes and values for the attributes. Note that the combination of an attribute and value are referred to as key/value pairs.

For example, suppose the desired file is a text document that is written in a blue Times New Roman font and includes the content of ‘hello world’ and is written in English. The request may include attributes (and their respective values) such as file-type (text), color (blue), font (Times New Roman), content (‘hello world’), and language (English). FIG. 2C depicts a file request formed using these key/value pairs.

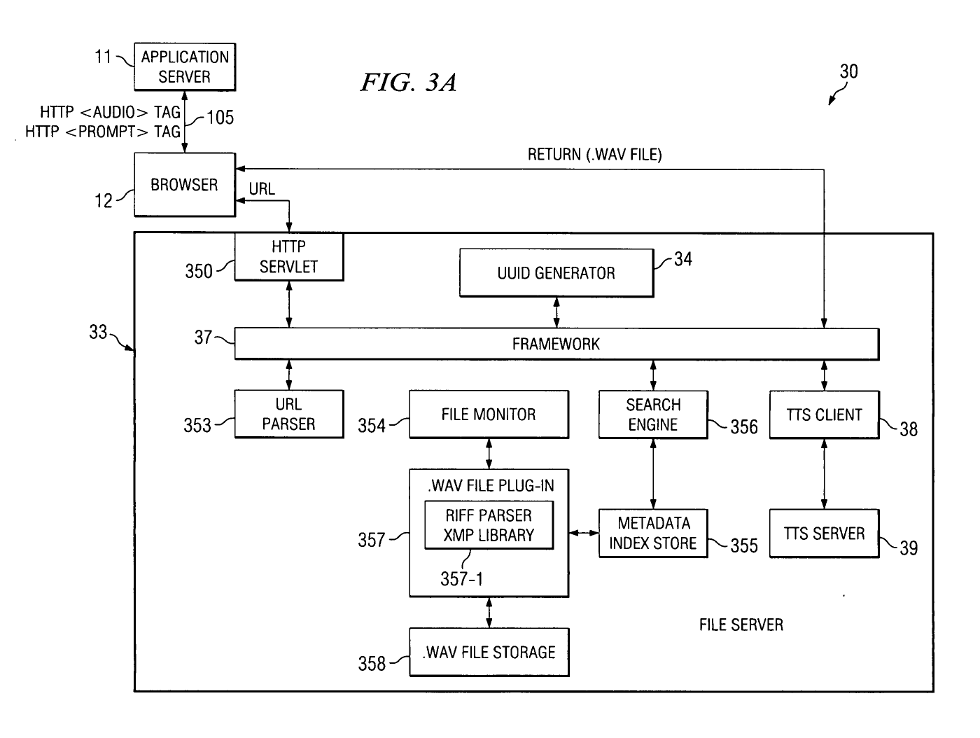

FIG. 3A shows one embodiment of system 30 for retrieving messages from file server 33 using attributes of the desired file rather than a full path name. These attributes are contained in an unresolved address structure. The fact that the address is not fully resolved means that the address of the desired file has not been specified. In this embodiment, file server 33 contains TTS client 38 and TTS server 39 to render audio files when such audio files have not been prerecorded or can not, for one reason or another, be retrieved from .wav file storage. In this case, one of the attributes specified in the query URL must be the audio file text so that the text can be passed to the TTS engine for rendering. As will be discussed, except for situations where the TTS engine might be used, the full text message may not be necessary to retrieve the specific file required. File server 33 can be an audio file server providing prompts to an IVR system working in conjunction with application server 11.

Advantage is taken of the HTTP protocol which allows data contained in a communication line to be passed to a target destination if that data falls after the query marker “?” in the communication line. Thus, by establishing file server 33 as the target, an application from, for example, application server 11, creates a document using the VXML scripting protocol. When browser 12 requests the document, application server 11 passes the document to browser 12, using, for example, the standard HTTP protocol.

Within the VXML document, there is a VXML audio tag, with a query URL describing various attributes of the required file, which may include the file's text, the speaker, and, its language. The audio tag causes an HTTP request to be sent to the file server including the query URL with all of its' attributes. The HTTP request does not have a fully-resolved address pointing to the specific audio file to be played. Instead, the HTTP request contains a query attribute string (metadata), which the file server uses to determine the appropriate prerecorded file to return to the browser. File server 33 must decode (or resolve for itself) which file message to return.

In such a situation it is possible to specify many attributes about the required file. Some of the most significant file attributes to be specified for an audio file would be the text of the utterance to be spoken, the speaker, and, the spoken language. Other attributes, such as whether the message was recorded by a male or female, or who recorded the message, the age of the recorder (child, adult, etc.), the emotional feel of the utterance, etc., can also be specified. In general, all metadata attributes are optional, but specific sets of attributes may be required in certain applications for correct operation. The file server then determines which file to retrieve based on the attributes specified in the request. In some applications, message IDs, and audio file set IDs will replace the audio file text as a key identifying element of the audio file.

FIG. 3B shows a portion of the VXML Script document, namely lines 300a-303a, that would be sent from application server 11 over channel 105 (in FIG. 3A) to browser 12 (the symbol “&” is used as a separator between key/value pairs) and is the command line for action taken by browser 12. FIG. 3C depicts a portion of the query URLs that would be generated by the browser based on the VXML Script, namely URLs 300b-303b. The query URL tells browser 12 what host it needs to direct to (host name) and which file server (file server 33) is the target. The query URL also tells browser 12 to get an audio file. Since the “?” stops the browser from translating the address further, the rest of the message, namely text=“your account balance is” & speaker=“John Smith” is passed to the file server 33 via ATTP servlet 350 and framework 37, as will be discussed. For example, line 300a of the VXML script will cause the formation of URL of line 300b, namely text=“your account balance is & speaker=John Smith”, which is passed to file server 33.

File server 33 resolves the final addressing in the audio file request URL and then parses the query attribute string via URL parser 353. The file server analyzes the various query attributes, looking each one up in a pre-generated attribute index, such as index store 355, of all of the audio files stored in the audio file server. The fully resolved message is then sent back to browser 12 from .wav file storage 358. If more than one file matches the search criteria, the file server will return the best match. If two or more files match equally, the audio file server will arbitrarily pick one of the equal set to return.

In FIG. 3B, line 301b is another example of a URL that is passed from browser 12 to file server 33, which was formed from the VMXL Script of line 301a. This message is identified as text =“hello world & gender=female and set=app123.” File server 33 then understands that the .wav file corresponding to “hello world” is to be retrieved with female voice in an application vocabulary that is appropriate for the application named app123.

Line 302b is a further example where it is desired to use the filename of the audio file which is a UUID such as 5D3G-4YSD6-AUNX8 as the identification. Line 302b was formed from the VMXL script of line 302a. The file server must resolve the location of this file by using its attributes. In this case, there is only one attribute—the Universal Unique ID (UUID). Using a UUID is important naming audio files for storage on the file server, since UUIDs have the property that they can be generated from many sources, but the chances of any generated UUID being the same as another is minimal. In this way, one can be certain with a high degree of confidence that the audio files will have unique names on the audio file server. Note that the UUID file name is usually assigned to the file before the file is placed on the server, just as the metadata is usually placed in a file before it is placed on the file server.

Line 303b is a URL that asks the file server to find the message, “your account balance is” spoken by female number 345, in French. Line 303b was formed from the VMXL script of line 303a. File server 33 upon receiving the message, requests search engine 356 (FIG. 2A) or any other mechanism, to determine the location of the message that matches the desired message. If no such message exists, optionally the message then could be passed to TTS server 39 via TTS client 38 to be rendered from scratch, as discussed above.

As discussed above with respect to messages 300 through 303, the file server had to identify which message was desired by parsing through the message, essentially by elimination. For example, assume message 303 is desired, then file server 33 would first find all messages with the words “Your account balance is.” Then the file server will, for example, narrow its search to files spoken by female 345 only, and only in French. Lastly, all of the remaining messages (i.e., “Your account balance is,” spoken by female 345 in all languages) will be eliminated, except for the message recorded in French. Thus, server 33 will return the message, “Your account balance is,” spoken in French by female 345. This message would typically be a .wav file and would be returned to browser 12 in response to communication line 303 being sent to browser 12 from, for example, application server 11. The returned file would still contain its metadata attributes, so the receiving entity can check the validity of the returned file.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A file server comprising:
a plurality of files;
means for receiving requests for selected ones of said files, said request including a set of attributes resolvable to identify a particular file; and
means for retrieving said particular file.

2. The file server of claim 1 wherein said receiving means comprises a communication line using the HTTP protocol.

3. The file server of claim 1 further comprising:
means for parsing the attributes from the request.

4. The file server of claim 1 wherein said receiving mean comprises providing said request and said attributes to said file server as a query URL.

5. The file server of claim 1 wherein one of said attributes is an identification of a desired content and wherein said retrieving means comprises:
means for identifying the universe of files matching said content; and
means for eliminating from said selection any of said identified files that do not match all of said attributes associated therewith.

6. The file server of claim 1 wherein said file server is an audio file server.

7. The file server of claim 6 wherein said audio file server provides prompts to an IVR system.

8. An audio file server comprising:
a system for selecting a particular audio file, said system operative to place attributes of said voice file associated with requests received for said audio file in an index store; and
a search engine for identifying said particular audio file from among a plurality of audio files based, at least in part, on said attributes placed in said index store.

9. The audio file server of claim 8 wherein said requests include an identification of said requested voice file together with said attributes which further uniquely identify audio file from a plurality of audio files.

10. The audio file server of claim 9 wherein said voice file is retrieved in .wav format.

11. The audio file server of claim 8 wherein said requests arrive at said prompt server as a query URL from a browser.

12. A web based IVR system comprising:
an application server for providing control for various applications that are available to users;
a voice browser interposed between said application server and said users, said voice browser operable for interfacing audio commands to/from said user and said application server and wherein certain of said commands from said application server contain requests identifying audio messages to be delivered to said user; and
a prompt server for receiving requests for audio files under control of said voice browser, said prompt server operable for retrieving a requested existing audio file for delivery to said user, wherein said retrieved audio file is identified by attributes associated with said requested file.

13. The system of claim 12 wherein said requests come to said voice browser on a HTTP protocol communication line commanded by the VXML scripting language on the browser.

14. The system of claim 13 wherein said request is included in said HTTP communication line as an attribute string to said communication line.

15. The system of claim 12 wherein said decoration comes after a marker in said communication lines.

16. The system set forth in claim 12 further comprising:
a text-to-speech converter for rendering text segments into audio when said prompt server is unable to retrieve a requested file.

17. The system of claim 12 wherein at least some of said audio files have been stored by a system user.

18. The system of claim 12 wherein said prompt server further comprises:
an indexing engine for matching attributes associated with said request with attributes stored in association with said audio files.

19. A method for retrieving files from a file server, said method comprising:
sending a query URL to a browser, said query URL addressing said file server, that leaves the specifically desired file unresolved; and
resolving the storage location of said specifically desired file by said file server.

20. The method of claim 19 wherein said resolving further comprises:
parsing attributes of the desired file from the query URL; and
searching for the desired file from among a plurality of files based on the parsed attributes.

21. The method of claim 19 further comprising:
providing the desired file to a requesting entity after locating the desired file.

22. A method for retrieving audio files from an audio file server, said method comprising:
creating an audio file request in the HTTP protocol, said audio file request addressing said audio file server and containing data pertaining to a desired audio file, but not address of location of said desired audio file; and
a browser for receiving said audio file request and for directing said data within said audio file request to an audio file server in accordance with said audio file-server-request.

23. The method of claim 22 further comprising:
resolving within said audio file server, the address location of said desired audio file based upon said directed data.

24. The method of claim 22 wherein said data contains a message statement and attributes of said message statement for uniquely identifying said desired audio file from among a plurality of possible statements that would otherwise match said provider message statement.
